(19) United States
(12) Patent Application Publication
(10) Pub. No.: US 2013/0318533 A1
(43) Pub. Date: Nov. 28, 2013

(54) METHODS AND SYSTEMS FOR PRESENTING AND ASSIGNING TASKS

(71) Applicants: Alexander Aghassipour, San Francisco, CA (US); Jake Holman, San Francisco, CA (US)

(72) Inventors: Alexander Aghassipour, San Francisco, CA (US); Jake Holman, San Francisco, CA (US)

(21) Appl. No.: 13/860,526

(22) Filed: Apr. 10, 2013

Related U.S. Application Data
(60) Provisional application No. 61/622,512, filed on Apr. 10, 2012.

(51) Int. Cl. G06F 9/48

(52) U.S. Cl. CPC G06F 9/4881
USPC 718/103

(57) ABSTRACT

Techniques for providing and controlling access to Tasks for prioritized resolution by a plurality of agents, which include receiving the Tasks, each Task having one or more associated characteristics; obtaining an identification of a first agent included in the plurality of agents; displaying to the first agent a first user interface for issuing a request for automated selection of a next Task for action by the first agent; selecting, in real time and in response to the request, the next Task for action by the first agent. The selection is based on a prioritization of the Tasks, wherein the prioritization is based on the identification of the first agent, and the selection does not include a Task displayed to another agent at the time of selection; and displaying to the first agent a second user interface allowing the first agent to take action on the selected next Task.

### CROSS-REFERENCE TO RELATED APPLICATIONS

This application claims priority to U.S. Provisional Patent App. No. 61/622,512, filed on Apr. 10, 2012, the disclosure of which is incorporated by reference in its entirety.

### FIELD OF THE DISCLOSURE

This application relates to methods, systems, and techniques for prioritized processing of a large number of tasks and/or issues, such as tasks to be performed by groups of customer service agents in communication with a business' customers.

### BACKGROUND

With the rise of the Internet, more and more ways arise for businesses to maintain and/or establish communication with customers. For example, customers can reach out to businesses via telephone, fax, email, live online chat, Voice Over IP (VOIP), videoconferencing, text-messaging, online bulletin boards and forums, business websites, and social networking services including Twitter and Facebook. With these technologies, there are many channels through which customers can contact business to resolve issues. In many situations, customer service issues involve an ongoing communication between business agents and customers with support issues. For example, a customer might seek assistance via one of the many channels listed above. This begins a dialogue, often not conducted in real-time, through which a customer and business exchange information to reach a resolution of the customer's issue.

The time needed to resolve a customer support issue can vary widely. For example, in some cases a single exchange may provide a customer with the needed information, whereas the next step in addressing a customer support issue might require waiting a number of days for an engineer to research the issue and propose and/or create solutions. In order to track customer support issues, electronic “trouble tickets,” and software for their storage and manipulation, have been used previously. U.S. Pat. No. 6,389,426 and U.S. Patent App. Pub. No. 2011/0066559, which are each incorporated by reference in their entireties, relate to conventional techniques for processing these “trouble tickets.”

Another example is the tools and services of Zendesk, which include a workflow management system for processing tasks or issues. Specifically, Zendesk provides tools and services by which customers of Zendesk's business users may submit tasks of issues via Zendesk's tools and services, which are further used to manage how such tasks or issues are handled by Zendesk's business users and agents working on their behalf. The aforementioned provisional patent application includes a document entitled “Getting Started with Zendesk,” which illustrates of some of the aspects of the Zendesk service, such as the collection, organization, and assignment of tickets to agents for their resolution. In this disclosure, the terms “agent,” “business agent,” and “business user” each refer to people working to resolve customer service issues on behalf of a business, typically by making use of tools or services such as Zendesk.

Conventionally, the workflow for resolving large numbers of customer support issues has involved the collection of support issue information into a large database of trouble tickets. Once in the database, a business may rely on a team of agents may work through them. For a database with a large number of trouble tickets, there is the concern of trouble tickets being lost or forgotten, and never brought to resolution. Conventionally, the solution for this issue has been assigning an “owner” for each trouble ticket, an agent designated as responsible for resolution of the trouble ticket. Until a trouble ticket reaches resolution, the trouble ticket may be reassigned many times, generally based on which agent is believed to be appropriate for at least the next step in reaching resolution of the trouble ticket.

### SUMMARY

The inventors of this application have identified a number of problems with conventional ownership-based trouble ticket processing methods and systems. First, the inventors have observed that individual agents will engage in “cherry picking,” where an agent scans through the trouble tickets assigned to the agent, and selects, or “picks off,” the easiest of the trouble tickets over more difficult trouble tickets.

Second, the inventors have observed that ownership-based techniques do not robustly handle situations in which an owner is unavailable, such as due to illness or departure from a business. In many cases, it is not until a customer registers a complaint that it is appreciated that tickets are effectively without an owner, as they are assigned to an agent who, at least at that time, is unavailable to work towards the resolution of those tickets.

Third, the inventors have observed that a large number of agents has difficulty in coordinating on which task each agent will be handling, particularly in situations in which agents are divided into teams, and tickets are assigned, at least initially, to a team rather than an individual agent. If care is not taken,

In this application, the inventors offer a number of techniques for improving upon or eliminating the above issues, and realizing more effective resolution of customer support issues while taking into consideration a business' priorities.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 illustrates an example graphical user interface 100 configured to present and provide access to collections of Tasks referred to as “Views.”

FIG. 2 illustrates a user interface 200 which avoids the problem of “cherry picking” by presenting Tasks to business users in a prioritized and modal fashion.

FIG. 3 illustrates an example user interface 300 configured to display a currently active Task selected for action by the business user.

FIG. 4 illustrates a system 400 and aspects of its operation for selecting a next Task to be acted on by a business user.

FIG. 5 illustrates aspects of another embodiment for identifying and displaying a next Task to be acted upon by a business user.

FIG. 6 illustrates an example user interface 600 whereby button 610 can be invoked by a business user to draw Tasks from this system-wide list of Tasks.

FIG. 7 illustrates an example user interface 700 in which a specific user configured Task list is used to identify and draw Tasks from all Tasks which have been updated in the last 12 hours.

FIG. 8 illustrates a network or host computer platform, as may typically be used to implement a server or other network element (e.g., a web server).

FIG. 9 illustrates a computer with user interface elements, as may be used to implement a personal computer (PC) or other type of work station or terminal device.

### DETAILED DESCRIPTION

Tasks and issues can represent any business process initiation request or customer reported issue/problem or action request—henceforth referred to as “Task”. The terms “ticket” and “case” are also used in connection with a “Task” in this disclosure. A plurality of Tasks are created and managed in the system and primarily categorized by their state. States range from “New”/“Open” all the way to “Closed”, typically with intermediate states. Business users, such as agents, select Tasks to act upon, act to resolve Tasks, and communicate with a Task requestor to complete the requested action and transition the matter to solved “Closed” state.

Over time, a large number of Tasks accumulate within a workflow or task management system, thereby requiring techniques to organize, order, prioritize, and sort Tasks such that business users can prioritize the processing of tickets in a more optimally coherent and logical sequence. Time since created, time since last responded to, urgency level, severity of underlying problem described under a task, prior review by other business users, and other prioritization factors are all common attributes used in Task presentation and ordering. In an embodiment, which factors are taken into consideration and/or how factors are considered for prioritization is at the discretion of the business user.

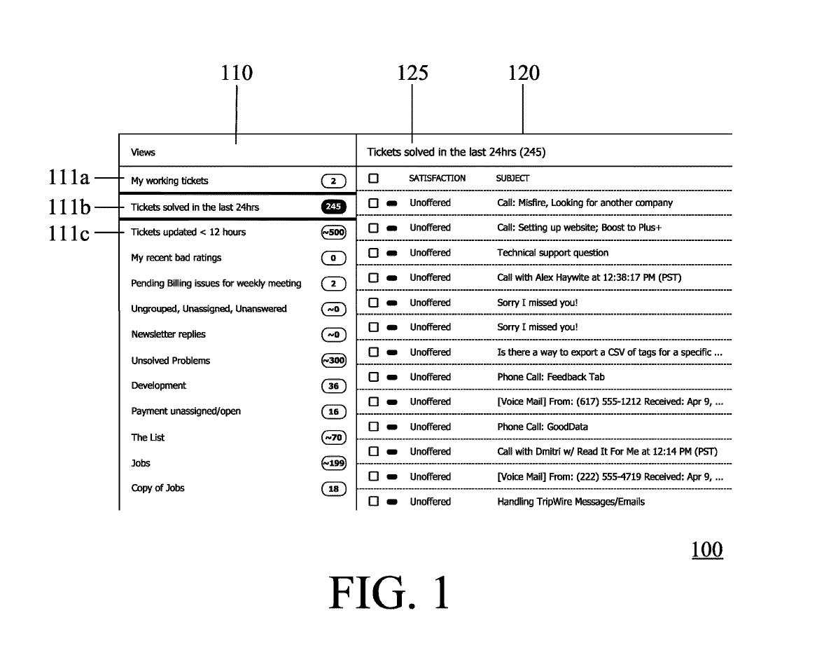

FIG. 1 illustrates an example graphical user interface 100 configured to present and provide access to collections of Tasks referred to as “Views.” In an embodiment, one or more Views can be customized to list a number of Tasks based on user-defined sets of parameters. Tasks included in a View may be identified based on a single criterion, such as an assignee, or on combinations of multiple criteria. By way of example, three types of Views might include:
1. System—This is a View defined by a manager/administrator which any business user can see and interact with.
2. Shared—Another View defined by a manager/administrator, but shared only with a subset of business users. For example, a view of “Finance” related tickets could be shared only with, and thus visible only to, business users that belong to the finance department.
3. Personal—A View created for and/or by an individual business user, and which is only visible to that business user. For example, a business user might create such a View if they only wanted to see a listing of tasks directly assigned only to them.

Cosmetically there need be no distinction between the types of View, but each View can contain its own subset of data, again defined by a manager/administrator. In some embodiments, a business user may only work within a single View, and not be able to select other Views.

In the example graphical user interface 100 illustrated in FIG. 1, on the left hand side is a list 110 of Views, such as Views 111a and 111b, which may be reviewed by a given business user. In the illustrated user interface 100, View 111b is labeled “Tickets solved in the last 24 hrs.” This label may provide a brief description of the Tasks that are included in the View. Additionally, next to the label is a numeric label, which indicates a number of unresolved Tasks in the view. This number may be approximate, as illustrated by View 111c. User interface 100 may be configured to permit the business user to select a View from list 110. User interface 100 may be configured, as illustrated in FIG. 1, to provide an indication, such as by a graphical highlight, of a selection of a View made by the business user. In the example illustrated in FIG. 1, View 111b is currently selected.

In FIG. 1, the right hand side of user interface 100 includes a list 120, which is configured to display Tasks included in a View selected from list 110. User interface 100 may be configured to, in response to a selection of a View from list 110, display Tasks included in the View in list 120.

In some embodiments, a manager/administrator may be able to separately configure each View so as to display certain information for each Task in this listing. For example, FIG. 1 illustrates a “satisfaction” column of the Task list 120. In some embodiments, a manager/administrator can specify rules for prioritizing or ordering Tasks within a View, in order to present more urgent Tasks at the beginning of a Task list 120.

User interface 100 may be configured to allow a business user to scroll through part of or all of the Task list 120, and pick and choose Tasks without regard to the order in which they are presented within the list. However, by selecting Tasks in such a manner, a business user may end up handling Tasks of lesser urgency than other Tasks pending within the View, leading to the issue of “cherry picking” discussed above.

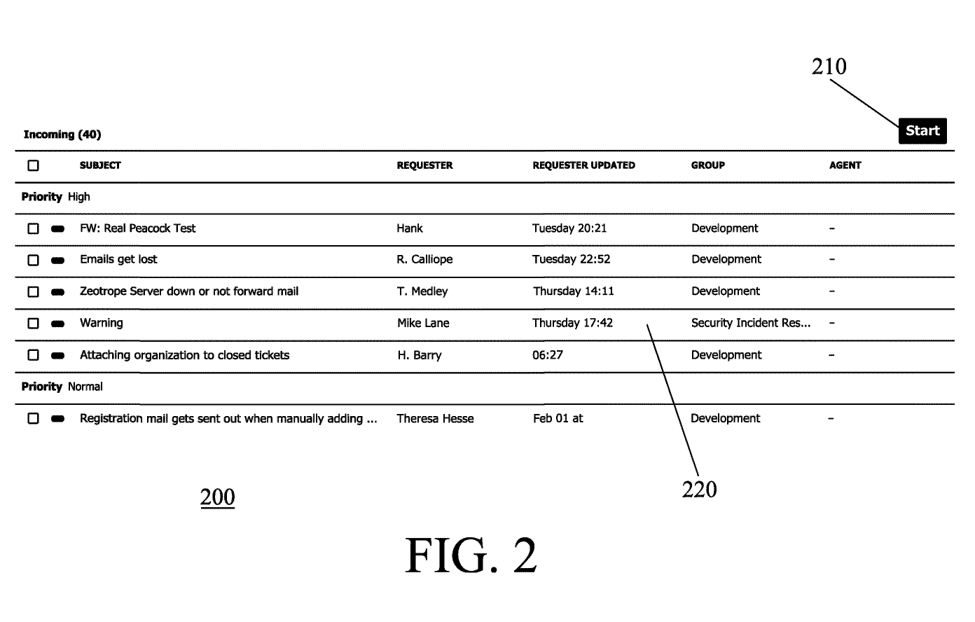

FIG. 2 illustrates a user interface 200 which avoids the problem of “cherry picking” by presenting Tasks to business users in a prioritized and modal fashion, such that while engaged in handling Tasks, a business user is not required, or even permitted, to make a determination about the next Task needing attention.

From a list of all Tasks in a View for the business user, the system may be configured to evaluate the current state of all Tasks in the list and determine the next most urgent Task, as discussed below in connection with system 400 and Task prioritization engine 420. Factors for determining the urgency or priority of Tasks may include:
The state of all Tasks in the system assigned directly to the business user.
The state of all Tasks currently visible to the business user but not yet assigned to any specific business user.
The date of last interaction of all Tasks in the list (e.g., when the most recent communication occurred for each Task).
The current activities of all other business users in the system, with a Tasks being viewed by any other user in the system at that moment being deprioritized in real time and/or removed from the list of possibly presentable Tasks.
A priority attribute or characteristic associated with a Task, such as high or normal priority, as illustrated in FIG. 2.

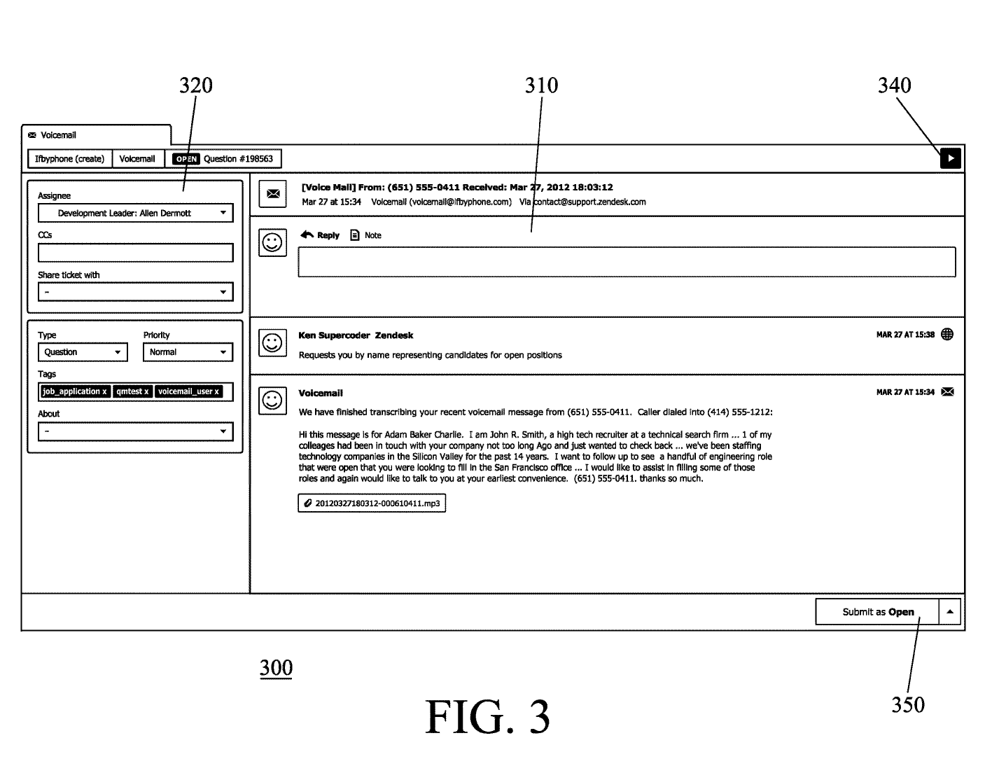

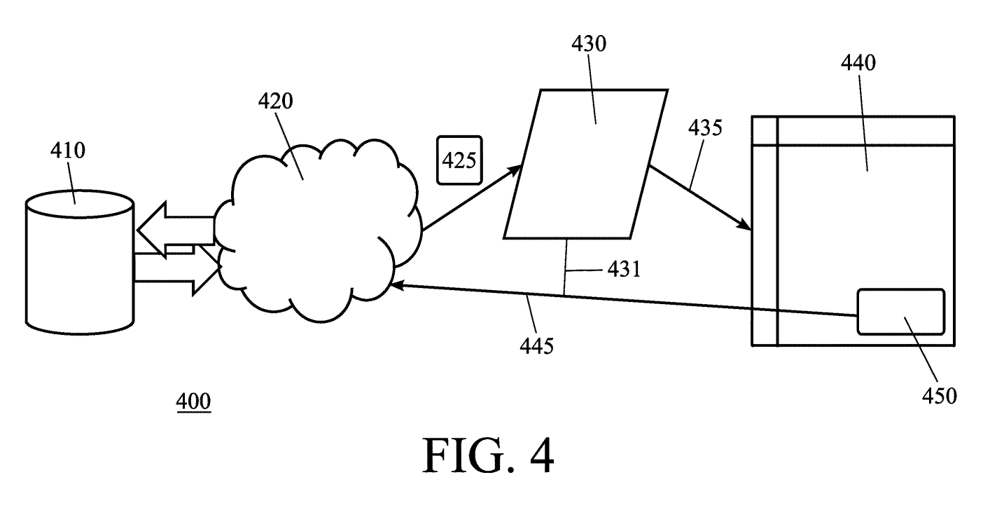

The example user interface 200 illustrates techniques for how Task handling may be invoked. FIG. 2 illustrates a Task list 220, much like Task list 120 illustrated in FIG. 1. Included with the display of Task list 220 is a “Start” button 210. When a business user presses the “Start” button 210, the business user is presented with a modal interface, such as user interface 300 illustrated in FIG. 3, whereby Tasks are presented to the business user, one at a time, in prioritized order. For example, assuming Task list 220 is displaying the Tasks according to their priority, as might be determined by Task prioritization engine 420 illustrated in FIG. 4, the Task labeled “Tuesday 20:21” would be the first Task presented to the business user. Then, after the business user dispatched this first Task, the second Task, labeled “Tuesday 22:52”, would be presented to the business user, assuming no new Tasks or modified Tasks with a higher priority for the business user had been introduced in the interim.

FIG. 3 illustrates an example user interface 300 configured to display a currently active Task selected for action by the business user. As illustrated in FIG. 3, user interface 300 may provide a modal display of the selected Task, to focus a business user's attention on that Task. As illustrated in FIG. 3, user interface 300 may be configured to present, in display area 310, a correspondence history for the selected Task. As illustrated in FIG. 3, user interface 300 may be configured to provide, in display area 320, user interface controls for viewing and modifying attributes of the selected Task, such as an assignee, priority, or textual tags associated with the Task.

User interface 300, as illustrated in FIG. 3, includes two user interface controls 340 and 350, which provide different ways to dispatch the Task. The first control 340, illustrated by the button at the top right corner of the display, allows the business user to skip the current Task without taking action on the Task. The second control 350, illustrated in the lower right hand corner of the display, allows the business user to take action on the Task and submit the action to the system. By way of example, FIG. 3 illustrates a pulldown button user interface element as an example of second control 350, by which clicking on the button would submit the Task as “Open,” and instruct the system to select and display the next Task.. Generally, a business user would invoke second control 350 after performing some action elsewhere in the display, such as by the controls illustrated in display area 320.

FIG. 4 illustrates a system 400 and aspects of its operation for selecting a next Task to be acted on by a business user. Task database 410 stores information associated with each Task managed by system 400. Task prioritization engine 420 is configured to determine and select from Task database 410 the next most urgent Task for a particular business user, based on predetermined factors and rules for their use. Much as discussed above, in an embodiment, system 400 may be configured to allow a business user to specify factors and rules employed by Task prioritization engine 420 for prioritizing Tasks. In this disclosure, discussion of a “priority” of a Task, such as a priority determined by Task prioritization engine 420, is generally not limited to a priority attribute (such as High or Normal), but refers to a more holistic factor-based determination.

System 400 is further configured to assess, at 430, whether any other business user is currently looking at selected Task 425. Path 431 illustrates that in the event another agent is currently looking at selected Task 425, system 400 is configured to reinvoke case prioritization engine 420 to select a new Task. Otherwise, as illustrated by path 435, selected Task 425 is displayed via business browser 440. User interface 300 in FIG. 3 illustrates an example of a business browser 440, and permits the business user to review and take action on selected Task 425. Much as discussed above with respect to second control 350 illustrated in FIG. 3, once the business has taken action on selected Task 425, business browser 440 may be configured to receive an indication of the action being taken via interface element 450. In response to this indication, as illustrated by path 445, system 400 is configured to save updated information for selected Task 425 in Task database 410, and proceed again, as described above, to use Task prioritization engine 420 to select another Task for the business user to act upon.

FIG. 4 illustrates a preferred embodiment, but those skilled in the art would understand that there are many other implementations within the skill of those of the art by which a similar result may be obtained. For example, by configuring Task prioritization engine 420 to request and/or receive only Tasks not being reviewed by other business users.

Thus, by way of the system 400 illustrated in FIG. 4, after each Task is processed by a business user, which may be indicated via second control 350 illustrated in FIG. 3, system 400 may be configured to redetermine the next most urgent Task, and further configured to automatically present this Task to the business user, such as via user interface 300. Much as discussed in connection with the first control 350 illustrated in FIG. 3, in some embodiments, system 400 may be configured to permit the business user to skip to the different Task without acting upon the Task displayed in business browser 440, and further configured such that the skipped Task is not presented again to the business user in the current Task handling session.

System 400 in FIG. 4 may be configured such that as new Tasks are selected for presentation, the currently open Tasks of all other business users in the system are monitored in real-time. With such a configuration, if a new Task is added to the View being processed by the business user, and case prioritization engine 420 determines the new Task has a higher priority than all currently actionable tasks, the new Task will be presented to the business user as the next Task. Also, if a Task is reprioritized, or another attribute of the Task is modified which affects its priority, and that Task is a higher priority than all currently actionable tasks, the Task will be presented to the business user as the next Task.

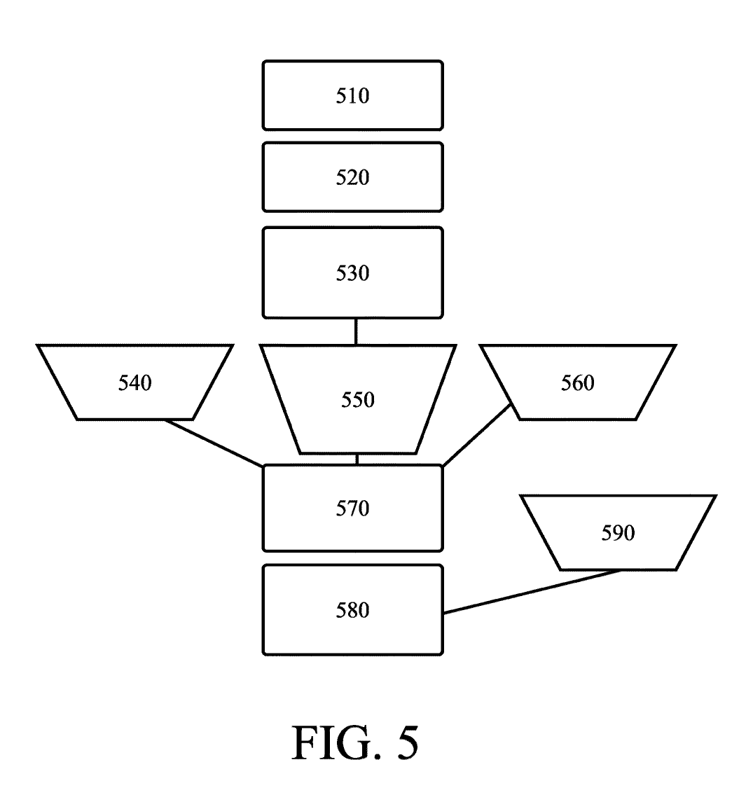

FIG. 5 illustrates aspects of another embodiment for identifying and displaying a next Task to be acted upon by a business user, prioritized simply by the last date of interaction for each Task, and then presented to a business user as discussed above much as described in connection with FIGS. 3 and 4. At step 510, a home screen/dashboard is displayed to the business user. At step 520, the business user enters the prioritized modal mode by clicking on a Start button. At step 530, the system selects all Tasks visible to the business user. At step 540, all Tasks directly assigned to the business user are identified. At step 550, Tasks unassigned to any user in the user's groups are identified. In step 560, all unassigned tasks are identified. In step 570, the Tasks identified in steps 540, 550, and 560 are ordered by their last date of customer interaction. In step 590, Tasks other users are viewing are identified. In step 580, the business user is presented with the first Task not included in those identified in step 590.

Items 430 and 580 illustrate that in some embodiments, although a Task might otherwise be determined, by Task prioritization 420, for example, to be the next Task for processing by a business user, if that Task is being viewed by another business user at that time, it will not be presented to the business user. Instead, another Task, the one of highest priority excluding that previous Task, is presented. In this way, “task collisions” between business users are avoided, and a common pool of Tasks can be more reliably handled by multiple business users without concern about more than one business user acting on the same Task.

Tasks can be grouped in many ways, whether grouping is specifically implemented as Views or otherwise. The disclosed techniques for assigning Tasks can be applied to any of those task list contexts. For example, Tasks system-wide may be considered, whereby all Tasks visible to the business user in the Task workflow system will be considered. In one example, one aspect of the prioritization may lend weight to Tasks presented in the following order:
a. all Tasks assigned directly to the business user
b. all Tasks visible to the business user, as part of the tasks assigned to the business users interest groups, but not assigned directly to another business user
c. all Tasks visible to the business user but not assigned directly to another business user and not part of the business users interest groups.

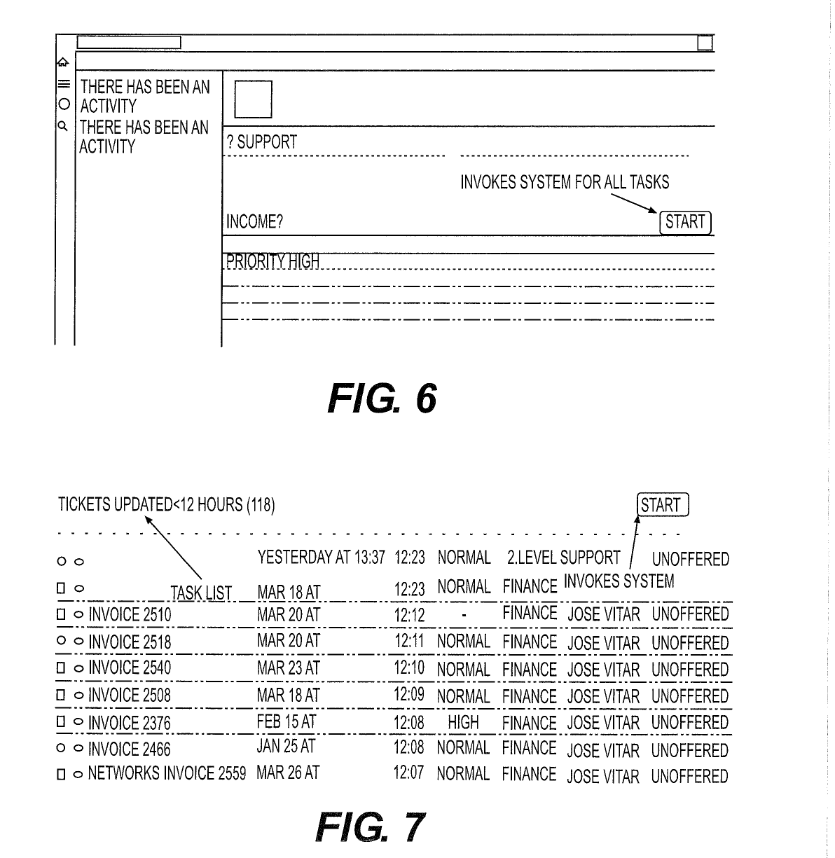

FIG. 6 illustrates an example user interface 600 whereby button 610 can be invoked by a business user to draw Tasks from this system-wide list of Tasks. Visible in the context of a business user's workflow system home screen, this system-wide list of Tasks represents the most urgent, not currently being handled list of Tasks from the entire workflow system. In an embodiment, both Task priority (as a Task attribute) and time since last interaction are factors for ordering tasks. By including the time since last interaction as a factor, the system avoids forgotten or long-neglected Tasks from not reaching resolution. In the case where a Task is naturally or purposely a long-running Task, it also allows for the Task to at least periodically be brought to someone's attention.

As another example of grouping Tasks, in an embodiment a business user may be able to create or at least make use of a specific user configured Task list, in which any characteristic or attribute of a Task (including, for example, creator, language, tags, keywords, key phrases, relative age of the Task, and business user grouping) can be used to create organized lists of Tasks. Examples include:
“My Working Tickets”—displays and pulls Tasks from the set of all “Open” state

Tasks directly assigned to a business user.
“Tickets Open for >24 Hrs”—displays and pulls from all Tasks that have been in the open state for more than one day. In some embodiments, such Tasks are still awaiting at least an initial review by a business user, which would likely lead to its assignment to a particular business user or business user group.

FIG. 7 illustrates an example user interface 700 in which a specific user configured Task list is used to identify and draw Tasks from all Tasks which have been updated in the last 12 hours. This Task list is dynamically generated, and might be used by a business user assigned to review the quality with which Tasks are being handled. In another example, the disclosed techniques for modal prioritized presentation of such groupings of Tasks, as might be invoked via the button 710 included in user interface 700, can enable processing of tasks within such lists using a variant of a core algorithm, wherein Tasks within a Task list will be presented by priority and age and current view state for all other business users in the system.

Variations of the System's Views

In an embodiment, administrators of the system's business users could configure the system so that business users within the business user's organization can only open Tasks in a home dashboard view of all Tasks in the system.

In an embodiment, administrators also could configure the system so that business users within the business user's organization can only access Tasks in a specific Task list.

In an embodiment, administrators could configure the system so that business users within the business user's organization do not have access to a skip button, such as first control 340. In such an embodiment, a Task must be acted upon before the business user can move to the next Task.

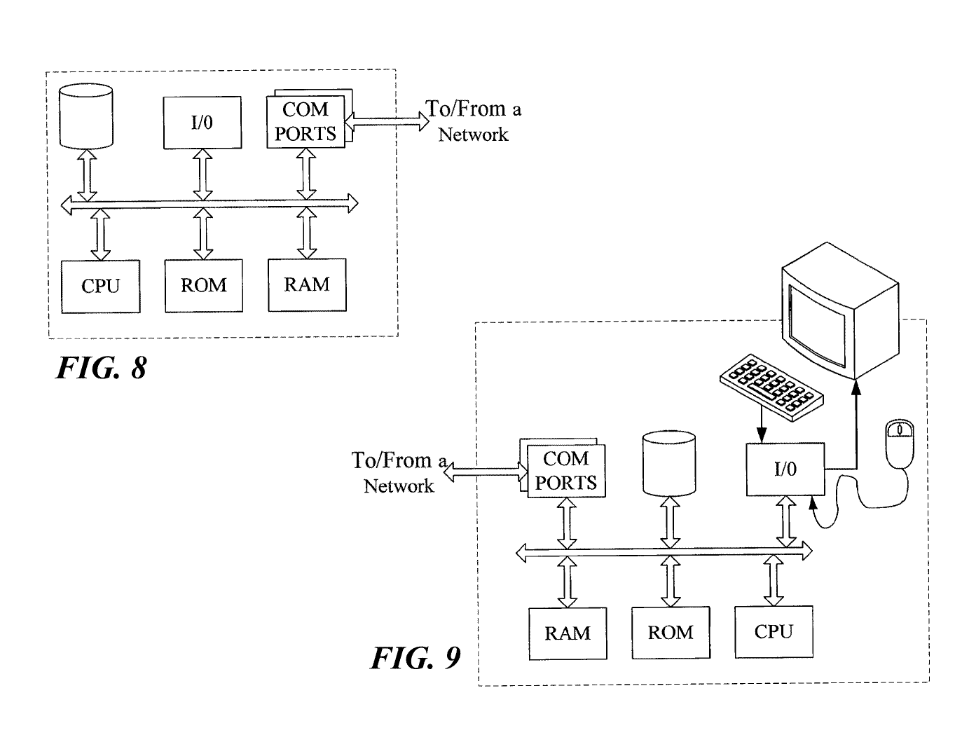

FIGS. 8 and 9 provide functional block diagram illustrations of general purpose computer hardware platforms. FIG. 8 illustrates a network or host computer platform, as may typically be used to implement a server or other network element (e.g., a web server). FIG. 9 illustrates a computer with user interface elements, as may be used to implement a personal computer (PC) or other type of work station or terminal device, although the computer of FIG. 9 may also act as a server if appropriately programmed. Those skilled in the art are familiar with the structure, programming and general operation of such computer equipment and as a result the drawings should be self-explanatory.

The hardware elements, operating systems and programming languages of such computers are conventional in nature, and it is presumed that those skilled in the art are adequately familiar therewith. Of course, the server functions may be implemented in a distributed fashion on a number of similar platforms, to distribute the processing load.

Hence, aspects of the disclosed techniques can be executed on a network element such as a server. Program aspects of the disclosed techniques may be thought of as “products” or “articles of manufacture” typically in the form of executable code and/or associated data that is carried on or embodied in a type of machine readable medium. “Storage” type media include any or all of the memory of the mobile stations, computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another computer or processor. For example, software and/or instructions may be communicated from a server to a client. Similarly, software for a server may be loaded into the hardware platform or platforms selected to perform that server function. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the data aggregator, the customer communication system, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

We claim:

1. A method of providing and controlling access to a plurality of Tasks for prioritized resolution by a plurality of agents, the method comprising:
receiving the plurality of Tasks, each Task having one or more associated characteristics;
obtaining an identification of a first agent included in the plurality of agents;
displaying to the first agent a first user interface including a first user interface element for issuing a request for automated selection of a next Task for action by the first agent;
selecting, in real time and in response to the request, the next Task for action by the first agent, wherein the selection is based on a prioritization of the Tasks, wherein the prioritization is based on the identification of the first agent, and the selection does not include a Task displayed to another agent at the time of selection; and
displaying to the first agent a second user interface allowing the first agent to take action on the selected next Task.

2. The method of claim 1, wherein the first user interface element does not include a user interface element for manual selection of a Task for action by the first agent.

3. The method of claim 1, wherein
the agents are associated with respective groups of agents; and
the prioritization is further based on a group with which the first agent is associated.

4. The method of claim 3, further including increasing a priority of a first Task by a first amount in response to the first Task being assigned to a group associated with the first agent.

5. The method of claim 4, further including increasing a priority of a second Task by a second amount greater than the first amount in response to the Task being assigned to the first agent individually.

6. The method of claim 1, further comprising:
obtaining ranking information specifying how one or more of the characteristics associated with Tasks affects the prioritization of the Tasks;
wherein the prioritization is further based on the obtained ranking information.

7. The method of claim 1, wherein
the selected next Task describes an issue associated with a first customer; and
the action taken by the first agent on the selected next Task includes communication with the first customer.

8. The method of claim 1, wherein
the second user interface further includes a second user interface element for issuing a request for automated selection of another Task for action by the first agent and for indicating the first agent did not take action on the next Task; and
the second user interface further includes a third user interface element for issuing a request for automated selection of another Task for action by the first agent and for indicating the first agent acted on the next Task.

9. The method of claim 1, wherein a second Task not assigned to the first agent is prioritized over a third Task assigned to the first agent, based on an amount of time the second Task has been awaiting action or resolution.
